(19) United States
(12) Patent Application Publication
(10) Pub. No.: US 2009/0081394 A1
(43) Pub. Date: Mar. 26, 2009

(54) Packaging Films

(76) Inventors: David Carew, Victoria (AU); Simon P. Hemmilton, Victoria (AU)

Correspondence Address: RYAN KROMHOLZ & MANION, S.C., POST OFFICE BOX 26618, MILWAUKEE, WI, 53226, US

(21) Appl. No.: 11/887,529

(22) PCT Filed: Apr. 3, 2006
(86) PCT No.: PCT/AU2006/000452

§ 371 Date: Nov. 17, 2008

(30) Foreign Application Priority Data
Apr. 1, 2005 (AU) 2005901614
May 2, 2005 (AU) 2005902214

(51) Int. Cl. B32B 1/02; B32B 27/36; B32B 27/34

(52) U.S. Cl. 428/34.8; 428/480; 428/474.7; 428/475.2

(57) ABSTRACT

A packaging film for use as at least a part of a package for food or beverage products is disclosed. The packaging film includes one or more than one layer. The one layer of the single layer film or a layer of the multilayer film that in use contacts a packaged product is formed from a packaging material in the form of a polymeric material that is a non-scalping polymer that does not absorb or absorbs only minimal amounts of flavour components of the packaged product.

The present invention relates to films for use in packages, such as containers, for products.

The films are referred to hereinafter as “packaging films”

The present invention also relates to packages, such as containers, that are made at least in part from the packaging films.

In particular, although by no means exclusively, the present invention relates to single or multiple layer packaging films for use in packages for food and beverage products that are made from packaging materials, such as polymer blends or other materials that are suitable for packaging food and beverage products.

Known packaging materials for use in packages for food and beverage products include, by way of example, polymeric materials such as low density polyethylene, high density polyethylene, polypropylene, ionomers, and ethylene and propylene copolymers.

The present invention relates more particularly, although by no means exclusively, to packaging films (and packages, such as containers, that are made at least in part from the packaging films) for use in packages for food and beverage products in situations where it is desirable or essential to limit adverse interactions between the packaging materials and the products which modify the concentrations of desirable components present in the products after filling the packages.

Most particularly, the present invention relates to packages, such as containers, for flavour sensitive products, such as wine, with the packages being made at least in part from packaging materials, such as packaging films, typically multiple layer co-extruded films, that are selected so that there is minimal, if any, absorption, i.e. scalping, of critical flavour components of the products by the packaging materials that affects adversely characteristic flavour profiles of the products.

Specifically, a problem with current packaging films for use in packages, such as containers, for food and beverage products is that the polymeric materials used to make the films, such as low density polyethylene, high density polyethylene, polypropylene, ionomers, and ethylene and propylene copolymers, absorb flavour components of the packaged products and thereby reduce the flavour of the packaged products.

The present invention relates to the use of alternative polymeric materials as the product contact layers of packaging films.

Specifically, the present invention relates to the use of polymeric materials which possess desirable properties in terms of minimising absorption of flavour components as the product contact layers of packaging films for use in packages for food products and that also have other desirable properties for packages for food products.

The other desirable properties for polymeric materials for packaging films include, by way of example, heat sealing properties. Heat sealing properties are required because in many situations packages, such as the bags used in casked wine or similar applications, that is formed from packaging films are formed by “heat sealing” adjacent sections of packaging films together. More specifically, the polymeric materials are often heated up to their melting point, which can range from 70 to 250° C., depending on the polymer, where upon they can be welded to adjacent sections of the same or different films, forming a strong and easy and cheap to manufacture bond. Hence heat sealability is a desirable property for packaging films.

The “heat sealing temperature” for a given polymer is understood in the art to mean the temperature range for which it will achieve a satisfactory heat seal for the intended application. As noted above, this can range from 70 to 250° C. A lower temperature is preferred as higher temperatures can start damaging the other polymeric materials that may be found within a multilayer packaging film. For this reason a heat sealing temperature of less than 160° C. is often thought to be beneficial for the manufacture of the inner bags used in casked wine.

According to the present invention there is provided a packaging film for use as at least a part of a package for food or beverage products, which packaging film includes one or more than one layer, and the one layer of the single layer film or a layer of the multilayer film that in use contacts a packaged product is formed from a packaging material in the form of a polymeric material that is a non-scalping polymer that does not absorb or absorbs only minimal amounts of flavour components of the packaged product.

Preferably the polymeric material has a melting point of less than 250° C. so that the packaging film can be folded or otherwise manipulated into a package shape and adjacent sections can be heat sealed together to form the package.

Preferably the polymeric material is heat sealable with a seal strength of greater than 1 KN/m, when measured by ASTM F88-00.

More preferably the seal strength of the polymeric material is greater than 2.5 KN/m, when measured by ASTM F88-00.

Preferably the polymeric material is heat sealable after less than 2 seconds of dwell time at the heat sealing temperature.

The polymeric material includes but is not limited to aromatic polyesters and copolymers, aliphatic polyesters and copolymers, polyamide polymers and copolymers, and polybutylene terephthalate (sometimes known as PBT) and copolymers.

Preferably the polymeric material is polyethylene tetraphhalte glycol (PETG)

The packaging material may further comprise additives which impart further functional properties such as physical property modification, emission of gases or liquids, or absorption of gases or liquids.

According to the present invention there is provided a package, such as a container, for food or beverage products that is formed at least in part from the above-described packaging film.

Preferably the package includes one or more than one heat sealed section formed by heat sealing adjacent sections of the polymeric material of the contact layer of the packaging film together with a seal strength of greater than 1 KN/m, when measured by ASTM F88-00.

Preferably the seal strength is greater than 2.5 KN/m.

The package may be a container in the form of a flexible film container, such as a “wine cask” or “bag-in-box” container for wine.

The flexible film container may also be used for containing olive oil, water, and other foods, beverages and fluids that are particularly sensitive to changes in taste after storage in containers made from polymeric materials due to absorption of one or more flavour components by the polymer materials.

A further example of the use of the flexible film container is where the flexible film container is used to contain wine during fermentation, storage or other production processes, such as that disclosed by Australian patent 763503 entitled “Materials handling apparatus and method”, in the name of Australian Vineyards Development Pty Ltd. This patent discloses the use of a flexible bag within a rigid support structure that retains fruit must in wine during in-bag fermentation of wine.

The successful use of non-scalping polymers in packaging films used as packages to contain wine in accordance with the present invention has been demonstrated by the applicant in a series of trials in which volatiles in wine being stored in contact with a series of resins were measured using known flavour extraction methods and gas chromatograph test methods.

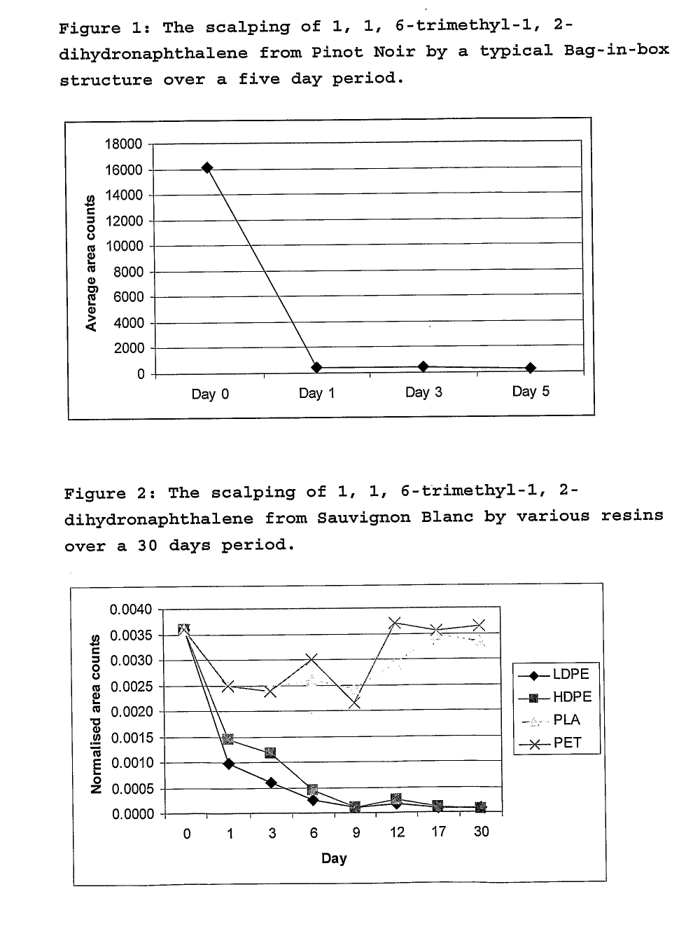

The trials are discussed below and the results of the trials are presented in FIGS. 1 to 4.

In each trial, a fresh sample of bottled, commercially available wine was used (new bottle, screw cap closure). Each sample was measured for volatiles before packing and then was used as a control. Control samples were stored at 4° C. The headspace of the bottled wine was flushed with nitrogen after each sampling period and then the bottle was resealed with a screw cap.

A reference material (naphthalene 1 ppb) was also measured for all samples to track any changes in gas chromatography technique performance.

The volatiles were measured using the following procedure: an aliquot of wine was placed in a clean 20 ml headspace vial, capped and subjected to a solid phase microextraction-gas chromatography-mass spectrum (SPME-GC/MS) method. The method measured volatile flavour components from the wine and tracked the loss of these components over time. A sample of wine was extracted at 37° C. for 30 minutes in the method. All samples were analysed in duplicate.

All of the trials focused on measuring the concentration of 1,1,6-trimethyl-1,2-dihydronaphthalene (TDN) as this is known to be an oxygen in-sensitive volatile characteristic flavour component of both white and red wines. Pollnitz et al (Proceedings Eleventh Australian Wine Industry Technical Conference, pages 162 to 164) noted that

“The compound most affected by storage in wine cask bladder was 1,1,6-trimethyl-1,2-dihydronaphthalene (TDN). This has a kerosene like aroma at high concentrations and is an important contributor to the aroma and flavour of some Riesling wines. Some 97% was apparently absorbed by the packaging; 75% of this absorption took place in the 24 hours of contact”.

TDN is also thought to be representative of other volatile non-polar flavour components, even if the absorption of these other compounds is not as strong.

### First Trial

Trial 1 was initiated to evaluate the scalping properties of the currently available bag-in-box structure.

A pinot noir wine was chosen for the study as pinot noir wines are characterised by delicate bouquets of flavour volatiles and therefore are likely to be impacted by flavour volatile scalping.

Samples bags (100 mm×194 mm) were hand sealed on two sides, 50 ml of pinot noir wine was added to each bag, headspaces were flushed for 2 minutes with nitrogen and the bags were sealed.

Bags were sampled at 1, 3 and 5 days. Sampling was done in duplicate.

The results of the trial are presented in FIG. 1.

FIG. 1 shows the scalping behaviour of a typical, currently available, bag-in-box packaging film in the trial. The results of this trial show a significant loss of TDN in the first day of the trial, consistent with the findings of Pollnitz et al discussed above.

### Second Trial

Four polymer resins were tested in this trial.

Brief details of the resins are set out in Table 1 below. The trade names of the resins was not noted as this was a preliminary trial.

TABLE 1

| | Density |
|---|---|
| Resins | (g/cm³) |
| Low density polyethylene (LDPE) | 0.920 |
| High density polyethylene (HDPE) | 0.949 |
| Polylactic acid (PLA) | 1.250 |
| Polyethylene Tetrathapalate (PET) | 1.370 |

The loss of 1,1,6-trimethyl-1,2-dihydronaphthalene from sauvignon blanc and pinot noir wines in contact with the four resins was measured.

The sauvignon blanc was a Waipara Hills 2003 sauvignon blanc (Malborough region, New Zealand) and the pinot noir was a Trentham Estate 2004 pinot noir (Trentham Cliff, New South Wales, Australia).

For this and the subsequent trial the following conditions were used: 0.2 gram of each resin was placed in a 20 ml empty vial and the vial was filled with wine until no headspace was present. Vials were capped with a Teflon coated butyl septa.

The vials were sampled at 1, 3, 6, 9, 12, 17 and 30 days after exposure to the resin.

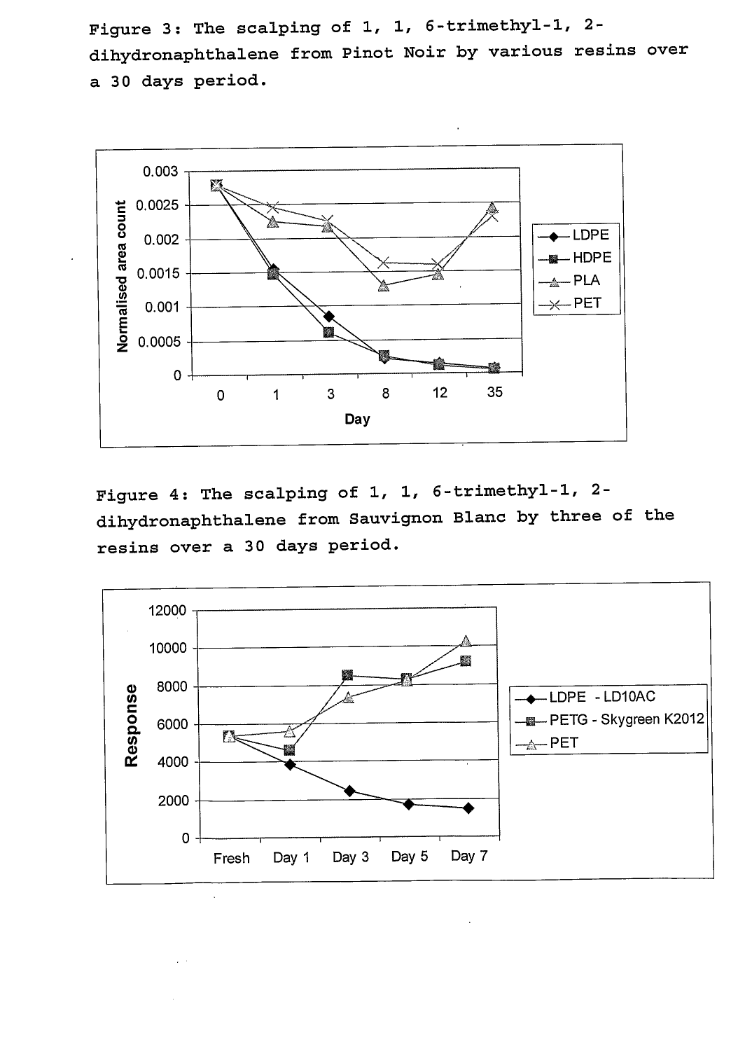

The results of the trial are presented in FIGS. 2 and 3.

FIGS. 2 and 3 show a loss of 1,1,6-trimethyl-1,2-dihydronaphthalene for the wine samples packed with the LDPE and HDPE. In contrast, there was no consistent change in TDN level for the wine packed with PLA and PET.

It is noted that PLA and PET have undesirable properties for bag-in-box applications that would need to be addressed prior to the use of the polymeric materials in these applications. PLA is prone to flex cracking and PET is hard to heat seal, which is important as the inner layer of the bag is heat sealed to form the bag structure.

The reason why polyesters show improved scalping behaviour is that the higher density of polyesters (due to a more crystalline structure) compared to LDPE and HDPE and other polymers currently used as packaging films for food and beverage products physically blocks the absorption of the volatile compounds in the polymers.

### Third Trial

In the third trial an expanded list of resins was used. Brief particulars of the resins are set out in Table 2.

TABLE 2

| | Type of | Density | |
|---|---|---|---|
| Resins | resin | (g/cm³) | Trade Name |
| LDPE | Polyolefin | 0.920 | LD10AC |
| Modified linear low | Polyolefin | 0.895 | DOWPF1140 |
| density polyethylene | | | |
| (mLLDPE) | | | |
| mLLDPE | Polyolefin | 0.923 | Evolue SP2320 |
| mLLDPE | Polyolefin | 0.930 | Evolue SP3010 |
| HDPE | Polyolefin | 0.949 | HYX800 |
| Polypropylene (PP) | Polyolefin | 0.910 | Inspire D114 |
| Polyethylene | Polyester | 1.270 | Skygreen K2012 |
| Tetraphhalte glycol | | | |
| (PETG) | | | |
| Ethylvinyl Acatate EVA | Polyolefin | 0.939 | Elvax 3165 |
| Surlyn | Polyolefin | 0.920 | 1601-2 |
| PET | Polyester | 1.370 | As before |

The same test procedure and the same sauvignon blanc wine used in the second trial were used in this trial.

The vials were sampled at 1, 3, 5, and 7 days after exposure to the resins.

The results are shown in Table 3, with key results plotted in FIG. 4.

TABLE 3
The scalping of 1,1,6-trimethyl-1,2-dihydronaphthalene from sauvignon blanc
by three of the resins over a 30 days period - numerical results.

| | Type of | | | | | |
|---|---|---|---|---|---|---|
| | resin | Fresh | Day 1 | Day 3 | Day 5 | Day 7 |
| LDPE - LD10AC | Polyolefin | 5400 | 3900 | 2400 | 1700 | 1500 |
| mLLDPE d = 0895 - | Polyolefin | 5400 | 4000 | 2700 | 1800 | 1800 |
| DOWPF1140 | | | | | | |
| mLLDPE d = 0.923 - | Polyolefin | 5400 | 420 | 3600 | 1500 | 2200 |
| Evolue SP2320 | | | | | | |
| mLLDPE d = 0.930 - | Polyolefin | 5400 | 5100 | 3800 | 2500 | 1700 |
| Evolue SP3010 | | | | | | |
| HDPE - HYX800 | Polyolefin | 5400 | 5000 | 4900 | 3600 | 3800 |
| Inspire PP - | Polyolefin | 5400 | 4400 | 5100 | 4300 | 5000 |
| Inspire D114 | | | | | | |
| PETG - Skygreen | Polyester | 5400 | 4600 | 8500 | 8500 | 9100 |
| K2012 | | | | | | |
| EVA - Elvax 3165 | Polyolefin | 5400 | 5300 | 2500 | 1000 | 1400 |
| Surlyn - 1601-2 | Polyolefin | 5400 | 5800 | 3400 | 1800 | 2000 |
| PET | Polyester | 5400 | 5600 | 7300 | 8200 | 10200 |

Table 3 and FIG. 4 show a range of scalping behaviour. In particular, the two polyesters show an increase in the TDN level, while the polyolefins all showed a decrease in TDN.

It is believed that the rise in TDN levels with the two polyesters PETG and PET may be due to the absorption properties of SPME, which have been known to vary, and/or TDN generation in the vial. TDN is a grape derived flavour—therefore, generation of this flavour compound post bottling is unlikely. The rise in concentration will be monitored in on-going trials.

This issue does prevent a conclusion that PETG and PET are suitable non-scalping because the overall trend of the results is that polyolefins (such as polyethylene) scalp non-polar flavours from wine and polyesters (such as PET, PLA, and PETG) do not scalp such flavours from wine.

Since PETG has suitable heating sealing properties for bag making, the results indicate that PETG, is particularly suitable for producing bag in box wines that do not scalp.

The heat sealability of PETG has been recognised previously. Specifically, U.S. Pat. No. 4,405,400 in the name of Petersen-Hoj discloses the use of PETG as a sealing layer in conjunction with other polymers.

Many modifications may be made to the present invention described above without departing from the spirit and scope of the invention.

1. A packaging film for use as at least a part of a package for food or beverage products, which packaging film includes one or more than one layer, and the one layer of the single layer film or a layer of the multilayer film that in use contacts a packaged product is formed from a packaging material in the form of a polymeric material that is a non-scalping polymer that does not absorb or absorbs only minimal amounts of flavour components of the packaged product.

2. The packaging film defined in claim 1 wherein the polymeric material has a melting point of less than 250° C. so that the film can be folded or otherwise manipulated into a package shape and adjacent sections can be heat sealed together to form the package.

3. The packaging film defined in claim 1 or claim 2 wherein the polymeric material is heat sealable with a seal strength of greater than 1 KN/M, when measured by ASTM F88-00.

4. The packaging film defined in claim 3 wherein the seal strength is greater than 2.5 KN/m, when measured by ASTM F88-00.

5. The packaging film defined in claim 1 wherein the polymeric material includes any one or more than one of aromatic polyesters and copolymers, aliphatic polyesters and copolymers, polyamide polymers and copolymers, and polybutylene terephthalate and co-polymers.

6. The packaging film defined in claim 5 wherein the polymeric material is polyethylene tetraphhalte glycol.

7. A package, such as a container, for food or beverage products that is formed at least in part from the packaging film defined in claim 1.

8. The package defined in claim 7 in the form of a flexible film container, such as a “wine cask” or “bag-in-box” container for wine.

9. The package defined in claim 7 or claim 8 includes one or more than one heat sealed section formed by heat sealing adjacent sections of the polymeric material of the contact layer of the packaging film together with a seal strength of greater than 1 KN/m, when measured by ASTM F88-00.

10. The package defined in claim 9 wherein the seal strength is greater than 2.5 KN/m.

11. A flexible film container, such as a “wine cask” or a “bag-in-box” container for wine, formed from a packaging film which includes one or more than one layer, wherein the one layer of the single layer film or a layer of the multilayer film in use contacts a packages product and is formed from a packaging material in the form of a polymeric material that is a non-scalping polymer that does not absorb or absorbs only minimal amounts of flavour components of the packaged product.

12. A “wine cask” or a “bag-in-box” container for wine, formed from a flexible packaging film which includes one or more than one layer, wherein the one layer of the single layer film or a layer of the multilayer film in use contacts a packaged product and is formed from a packaging material in the form of a polymeric material that is a non-scalping polymer that does not absorb or absorbs only minimal amounts of flavour components of the packaged product.

13. A “wine cask” or a “bag-in-box” container for wine, the “wine cask” or a “bag-in-box” container being formed from a flexible packaging film which includes one or more than one layer, wherein the one layer of the single layer film or a layer of the multilayer film in use contacts a packaged product and is formed from a packaging material in the form of a polymeric material that is a non-scalping polymer that does not absorb or absorbs only minimal amounts of flavour components of the packaged product.
